(19) United States
(12) Patent Application Publication
(10) Pub. No.: US 2016/0034003 A1
(43) Pub. Date: Feb. 4, 2016

(54) ELECTRONIC DEVICE

(71) Applicants: SHENZHEN FUTAIHONG PRECISION INDUSTRY CO., LTD., Shenzhen (CN); FIH (HONG KONG) LIMITED, Kowloon (HK)

(72) Inventors: NAI-LIN YANG, New Taipei (TW); BING ZHANG, Shenzhen (CN); HAN-YUN XIA, Shenzhen (CN); SHI-FENG WANG, Shenzhen (CN)

(21) Appl. No.: 14/556,988

(22) Filed: Dec. 1, 2014

(30) Foreign Application Priority Data
Aug. 1, 2014 (CN) 201410375844.4

(51) Int. Cl. G06F 1/16

(52) U.S. Cl. CPC G06F 1/1656

(57) ABSTRACT

An electronic device includes a housing, a buffer layer, a display, and a printed circuit board. The housing includes a main body with a front side having an outer peripheral edge and a first surface and a peripheral side extending from the outer peripheral edge of the front side. The front side and the peripheral side cooperate to form a receiving recess with the first surface of the front side facing the receiving recess. The buffering layer is positioned on a portion of the first surface. The display is received into the receiving recess. The printed circuit board is received into the receiving recess and coupled to the display. The buffering layer includes elastic material and conductive material. The buffering layer is positioned between the first surface and the display.

### FIELD

The disclosure generally relates electronic devices, and particularly to an electronic device having a display protective function.

### BACKGROUND

An electronic device commonly includes a housing and a display mounted onto the housing for showing information. The display is generally assembled to the housing by solder, adhesives, or held together by latching clips.

However, the structure of the conventional housing may not able to withstand impact forces such as those occurring when the device is dropped, or when struck by another object, especially if the impact forces are concentrated on the display of the device.

### BRIEF DESCRIPTION OF THE DRAWINGS

Implementations of the present technology will now be described, by way of example only, with reference to the attached figures.

FIG. 1 is an isometric view of an electronic device, according to an exemplary embodiment.

FIG. 2 is an exploded, isometric view of the electronic device of FIG. 1.

FIG. 3 is an isometric view of a housing of the electronic device of FIG. 1.

FIG. 4 is a cross-sectional view of the housing of FIG. 3 along line IV-IV.

FIG. 5 is a cross-sectional view of the electronic device of FIG. 1 along line V-V.

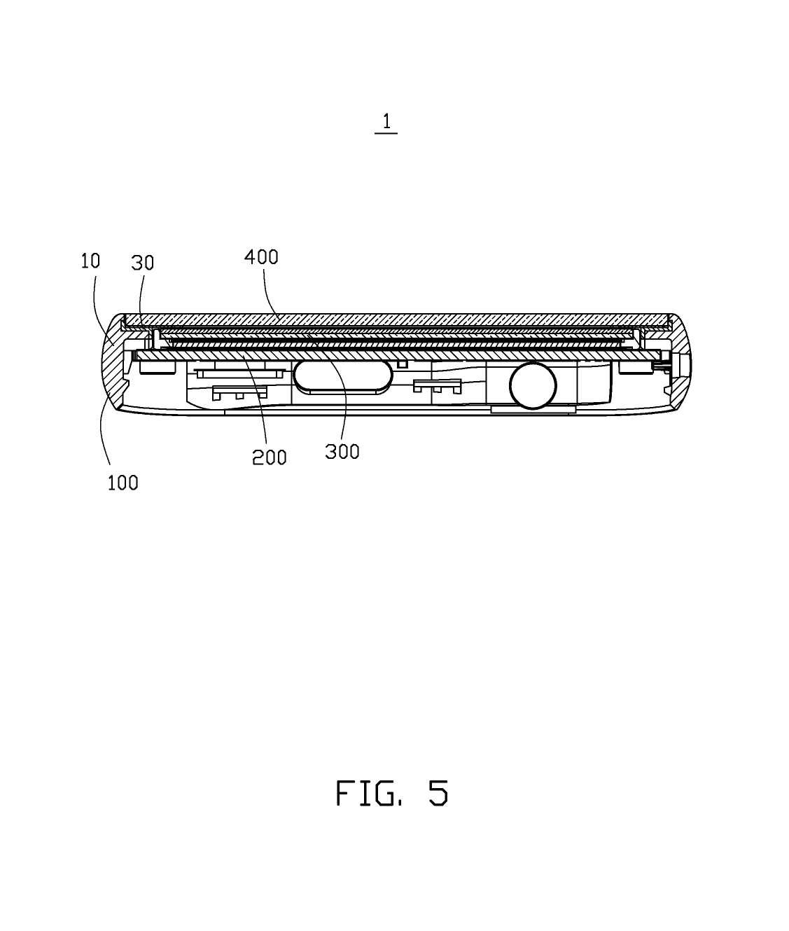

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

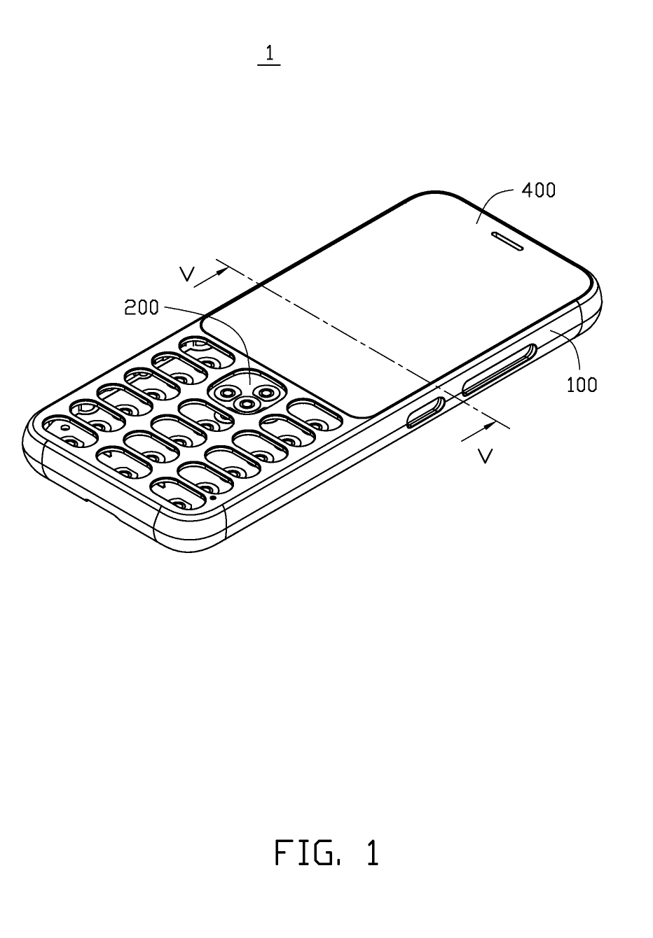

FIG. 1 is an isometric view of an electronic device 1, according to an exemplary embodiment. The electronic device 1 may be mobile phone, electronic reader, MP3 player, etc. The electronic device 1 includes a housing 100, a printed circuit board (PCB) 200, a display 300, and a screen guard 400. The display 300 is assembled to the PCB 200 and received in the housing 100. The screen guard 400 covers a portion of the housing 100 to protect the display 300.

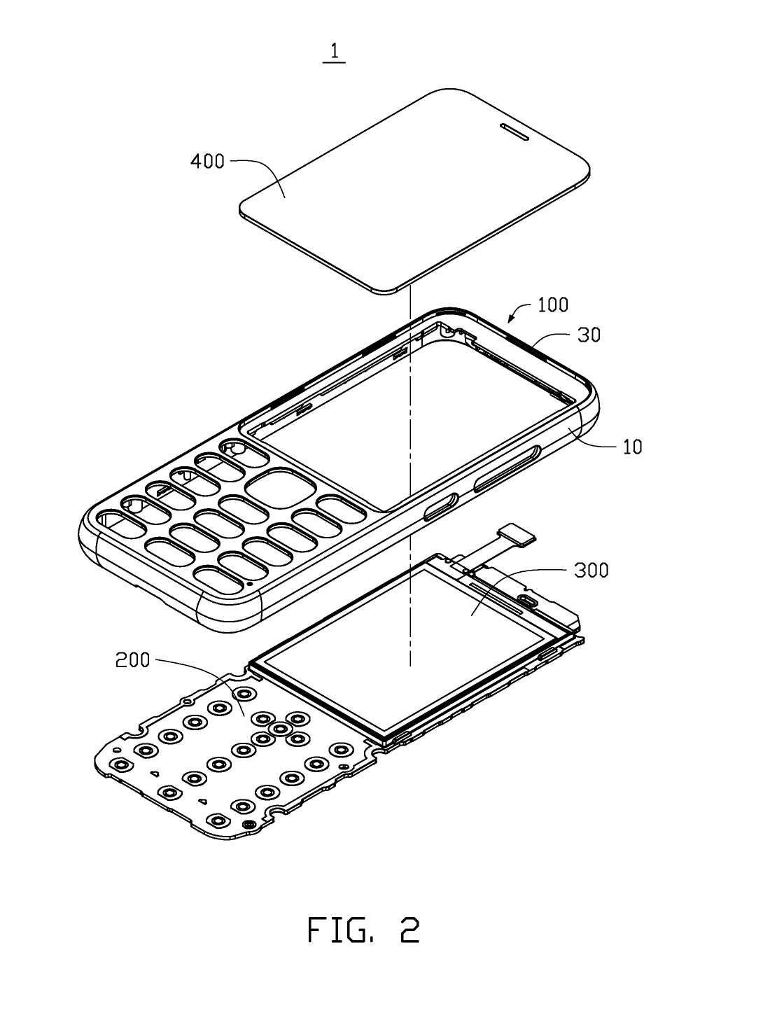

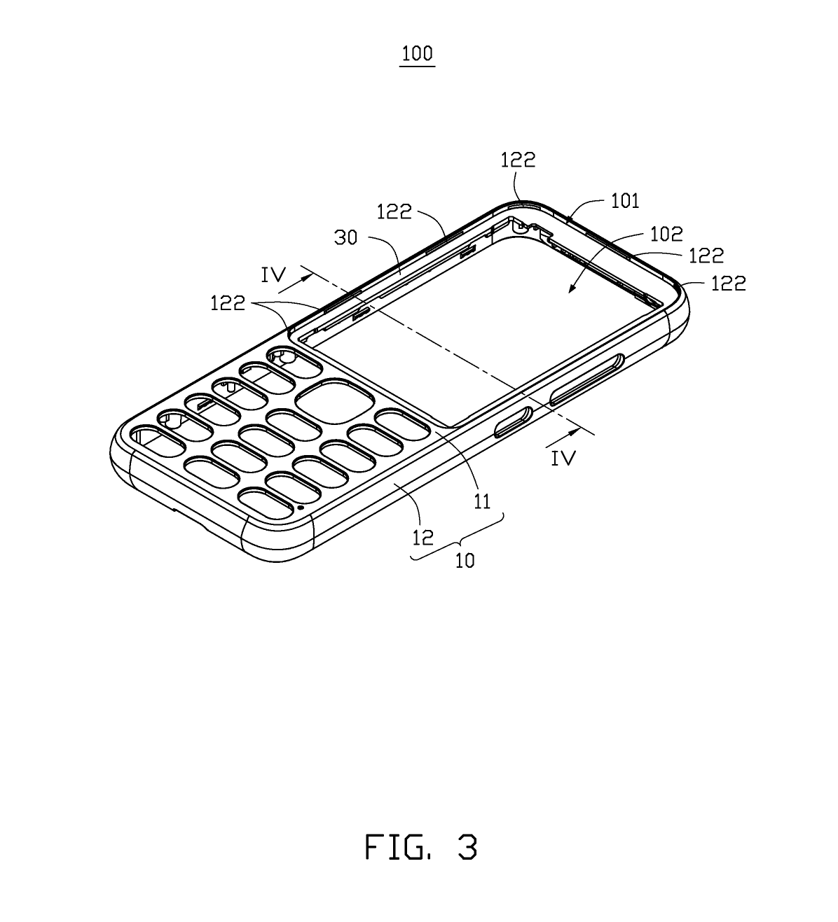

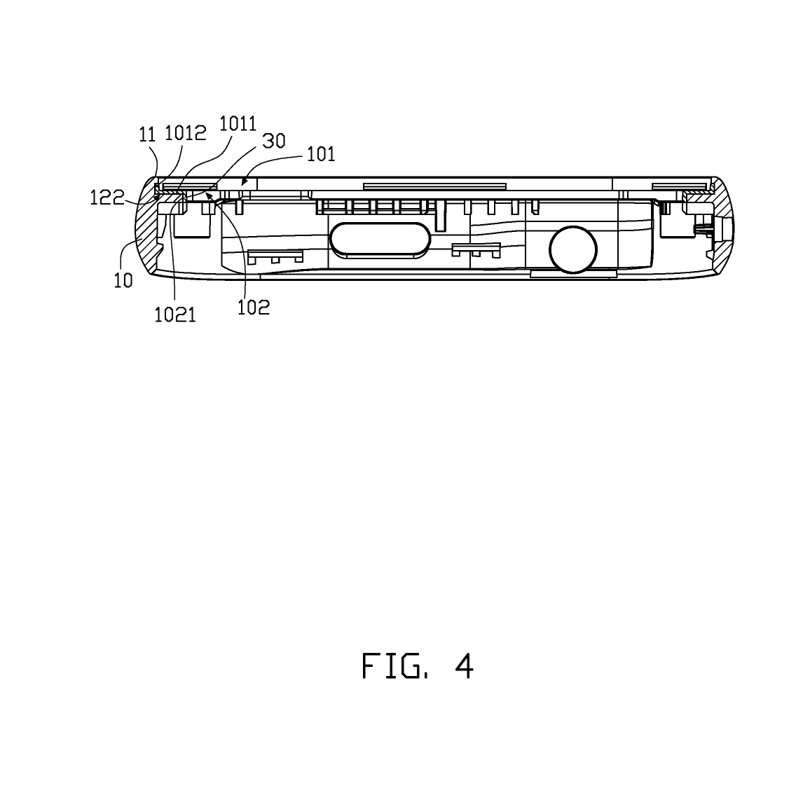

FIG. 2 shows that the housing 100 includes a main body 10 and a buffering layer 30. In this exemplary embodiment, the main body 10 is made of a hard plastic material such as polycarbonate. Referring to FIG. 3 and FIG. 4, the main body 10 includes a top wall 11 and a side wall 12 extending from periphery of the top wall 11. The top wall 11 is recessed to form a receiving recess 101. The receiving recess 101 includes a bottom surface 1011 and an inner surface 1012 extending from periphery of the bottom surface 1011. The bottom surface 1011 defines a through hole 102 and forms a side surface 1021 surrounding the hole 102. In this exemplary embodiment, the receiving recess 101 and the hole 102 are substantially rectangular. The inner surface 1012 is recessed to form a plurality of slots 122. The slots 122 communicate with the receiving recess 101. In this exemplary embodiment, there are ten slots 122 positioned around the receiving recess 101 and spaced from each other. The inner surface 1012, the bottom surface 1011, and the side surface 1021 are perpendicularly connected to form a step-shaped section.

The buffering layer 30 is made of an elastic conductive material which may be made by adding thermoplastic polyurethanes into conductive material. Dielectric and hardness coefficients of the buffering layer 30 are about 8.5-14.4M/Hz and 30-65 shore00. The buffering layer 30 is filled in the slots 122 in a molten state from a mold (not shown) and covers the bottom surface 1011 and the side surface 1021 to combine with the main body 10 by double shot molding method.

In assembly, the display 300 is secured on the PCB 200. The PCB 200 is received in the housing 100 and electrically connected to the buffering layer 30. The display 300 is received in the hole 102. The screen guard 400 is received in the receiving recess 101. The screen guard 400 covers the display 300 and resists against the buffering layer 30.

When the electronic device 1 is dropped, or when struck by another object, because of the buffering layer 30 sandwiched between the main body 10 and screen guard 400 and the display 300, the shock-absorbing properties of the electronic device 1 is significantly improved.

In addition, a gap between the screen guard 400 and the housing 100 is sealed by the buffering layer 30. Therefore, dust and water can be prevented from entering into the electronic device 1.

Furthermore, when static electricity exists the housing 100, the buffering layer 30 conducts the static electricity to the PCB 200 to avoid the static electricity from reaching the display 300 and effectively protect the display 300 from static damage.

It is to be understood, however, that even through numerous characteristics and advantages of the present disclosure have been set forth in the foregoing description, together with details of assembly and function, the disclosure is illustrative only, and changes may be made in detail, including in the matters of shape, size, and arrangement of parts within the principles of the disclosure to the full extent indicated by the broad general meaning of the terms in which the appended claims are expressed.

What is claimed is:

1. An electronic device comprising:
a housing having:
a main body with:
a front side having an outer peripheral edge and a first surface; and
a peripheral side extending from the outer peripheral edge of the front side;
wherein, the front side and the peripheral side cooperate to form a receiving recess with the first surface of the front side facing the receiving recess;
a buffering layer positioned on a portion of the first surface;
a display received into the receiving recess; and
a printed circuit board received into the receiving recess and coupled to the display;
wherein, the buffering layer includes elastic material and conductive material;
wherein, the buffering layer is positioned between the first surface and the display.

2. The electronic device of claim 1, further comprising a screen guard covering the display, wherein the screen guard is received in the receiving recess and resists against the buffering layer.

3. An electronic device comprising:
a housing comprising:
a main body defining a receiving recess, the receiving recess comprising a bottom surface and an inner surface extending from periphery of the bottom surface; and
an elastic and conductive buffering layer covering the bottom surface;
a printed circuit board (PCB) received in the housing; and
a display assembled to the PCB and received in the receiving recess; wherein the buffering layer is sandwiched between the main body and the display.

4. The electronic device of claim 3, wherein the bottom surface defines a through hole and forms a side surface surrounding the hole, the buffering layer covers the side surface, the display is received in the hole.

5. The electronic device of claim 3, further comprising a screen guard covering the display, wherein the buffering layer covers the bottom surface, the screen guard is received in the receiving recess and resists against the buffering layer.

6. The electronic device of claim 5, wherein the inner surface, the bottom surface, and the side surface are perpendicularly connected to form a step-shaped section.

7. The electronic device of claim 3, wherein the main body comprises a top wall, the top wall is recessed to form the receiving recess.

8. An electronic device comprising:
a housing comprising:
a main body defining a receiving recess, the receiving recess comprising a bottom surface and an inner surface extending from periphery of the bottom surface; and
an elastic and conductive buffering layer;
a printed circuit board (PCB) received in the housing;
a display assembled to the PCB and received in the receiving recess; and
a screen guard covering the display; wherein the buffering layer seals the main body.

9. The electronic device of claim 8, wherein the bottom surface defines a through hole and forms a side surface surrounding the hole, the buffering layer covers the bottom surface and the side surface, the display is received in the hole.
